(19) United States
(12) Patent Application Publication
(10) Pub. No.: US 2018/0225179 A1
(43) Pub. Date: Aug. 9, 2018

(54) ENCRYPTED DATA CHUNKS

(71) Applicant: HEWLETT PACKARD ENTERPRISE DEVELOPMENT LP, Houston, TX (US)

(72) Inventors: Dave Donaghy, Bristol (GB); Shiraz Billimoria, Bristol (GB); Adam Richard Heath, Bristol (GB)

(21) Appl. No.: 15/749,574

(22) PCT Filed: Aug. 7, 2015
(86) PCT No.: PCT/US2015/044143

§ 371 Date: Feb. 1, 2018

(51) Int. Cl. G06F 11/14; G06F 17/30; H04L 9/06

(52) U.S. Cl. CPC G06F 11/1464; G06F 11/1448; H04L 9/0643; G06F 17/30073; G06F 11/1469

(57) ABSTRACT

Examples disclosed herein relate to data encryption instructions to divide a data element into a plurality of data chunks, encrypt the plurality of data chunks, store the encrypted plurality of data chunks in a local storage, and provide the data element to a remote backup storage.

### BACKGROUND

Data is often sent from numerous client devices to a storage server and/or multiple storage servers. In some situations, the data may then be removed from the client device. For example, an application running on a client device may send transaction logs to a storage server, then overwrite the logs with new data as more transactions occur.

### BRIEF DESCRIPTION OF THE DRAWINGS

In the accompanying drawings, like numerals refer to like components or blocks. The following detailed description references the drawings, wherein:

FIG. 1 is a block diagram of an example data encryption device;

FIG. 2 is a flowchart of an example of a method for providing data encryptions; and

FIG. 3 is a block diagram of an example system for providing data encryptions.

### DETAILED DESCRIPTION

In a networked computing environment, data may be stored in multiple backup locations across a network. For example, data may be backed up from many clients into fewer remote backup targets. While efforts are taken to prevent data loss on backup targets, on occasion data loss may occur. In some situations, the data lost from the backup target may be maintained in an encrypted, recoverable copy on the clients.

For example, the original data may be broken into chunks and encrypted on the client to enable recovery of the data from the client in case of loss on the backup target. Because the original data may be stored in an encrypted format, data that is sensitive in some way may restrict access to the data by the client and the security of the (potentially sensitive) data may be retained.

When clients transmit their data elements to a target, they may split them into chunks, calculate hash values representing those chunks, encrypt the chunks, and store the encrypted chunks in a local storage. The local storage may be indexed according to the hash value. The chunk size may be defined by the client and/or the backup target and communicated between them. The size may be used to verify the data after transmission to the backup target. The encryption format may be based on an asymmetric algorithm with a public encryption key provided by the backup target such that the client is not able to decrypt the data with this key. The backup target may have the corresponding, private decryption key. The hash value associated with the data chunk may be calculated according to a hash function such as MD5. Deletion of data on the client(s) may be permanent from the point of view of the client; it cannot recover the item without further the private decryption key from the backup target.

On the backup target, hashes for the data chunks may be calculated using the same hash function and stored independently of the data chunks. Any potential loss of the data chunks may thus not involve loss of the hash values. In the event of loss of the data chunks on the backup target, the backup target may query the clients for the corresponding chunk data. For example, if a backup target has lost data chunk C, then it may query all clients with the hash value for data chunk C. A client that has an encrypted data chunk corresponding to the hash value for data chunk C may send that encrypted data chunk back to the backup target. The backup target may decrypt the encrypted data chunk from the client to recover the missing data chunk C.

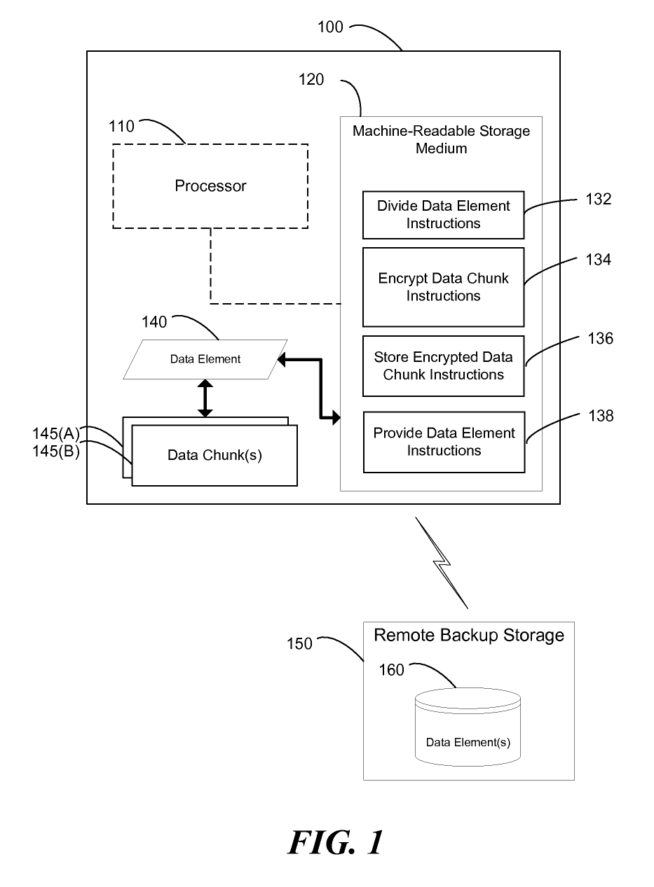

Referring now to the drawings, FIG. 1 is a block diagram of an example data encryption device 100 consistent with disclosed implementations. Data encryption device 100 may comprise a processor 110 and a non-transitory machine-readable storage medium 120. Data encryption device 100 may comprise a computing device such as a server computer, a desktop computer, a laptop computer, a handheld computing device, a smart phone, a tablet computing device, a mobile phone, a network device (e.g., a switch and/or router), or the like.

Processor 110 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 120. In particular, processor 110 may fetch, decode, and execute a plurality of divide data element instructions 132, encrypt data chunk instructions 134, store encrypted data chunk instructions 136, and provide data element instructions 138 to implement the functionality described in detail below.

Executable instructions may comprise logic stored in any portion and/or component of machine-readable storage medium 120 and executable by processor 110. The machine-readable storage medium 120 may comprise both volatile and/or nonvolatile memory and data storage components. Volatile components are those that do not retain data values upon loss of power. Nonvolatile components are those that retain data upon a loss of power.

The machine-readable storage medium 120 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Divide data element instructions 132 may divide a data element into a plurality of data chunks. For example, device 100 may comprise a client backing up a data element 140 such as log(s)s, video(s), image(s), application(s), and/or other data to a remote backup storage device 150. Data element 140 may be broken into a plurality of data chunks 145(A)-(B). The size of data chunks 145(A)-(B) may comprise a configurable size that may be defined by device 100 and/or remote backup storage device 150. The size of data chunks 145(A)-(B) may be type specific (e.g., a video file may be broken into different size chunks than a text file) and/or may vary based on the size of data element 140 (e.g., each data element may be broken into X number of data chunks, where X may comprise a configurable value). In some implementations, the size of the data chunk may comprise a predefined size (e.g., two megabytes) for any type and/or size data element.

In some implementations, remote backup storage device 150 may comprise a computing device in communication with device 100, such as via a network. In some implementations, remote backup storage device 150 may comprise an application and/or service executing on device 100 and/or another computing device.

Encrypt data chunk instructions 134 may encrypt the plurality of data chunks 145(A)-(B). For example, remote backup storage device 150 may generate a public/private key pair according to a public key infrastructure. The public key may be provided to device 100 for use in encrypting data chunks 145(A)-(B).

Store encrypted data chunk instructions 136 may store the encrypted plurality of data chunks in a local storage. For example, device 100 may write encrypted data chunks 145(A)-(C) to machine-readable storage medium 120 and/or some other storage location accessible to device 100 other than remote backup storage device 150. In some implementations, store encrypted data chunk instructions 136 may comprise instructions to store the encrypted plurality of data chunks in the local storage comprise instructions to store the encrypted plurality of data chunks in a hidden location of the local storage. For example, the encrypted data chunks 145(A)-(B) may be stored in a hidden folder and/or may be stored with permissions that prevent access by a user of device 100.

In some implementations, store encrypted data chunk instructions 136 may comprise instructions to calculate a hash value for each of the encrypted plurality of data chunks. For example, an md5 hash value may be calculated for each of data chunks 145(A)-(B). The hash value may be calculated on the encrypted and/or unencrypted format of the data chunks 145(A)-(B). The hash value may be used to index the data chunks 145(A)-(B), such as by creating a memory map and/or data table cross-referencing the hash value with the storage location for its respective data chunk.

Provide data element instructions 138 may provide the data element 140 to a remote backup storage device 150. Data element 140 may be provided to remote backup storage device 150 in its original undivided form and/or as plurality of data chunks 145(A)-(B) in an encrypted and/or unencrypted format for storage with other data elements 160. Provide data element instructions 138 may further comprise instructions to delete the data element from the local storage.

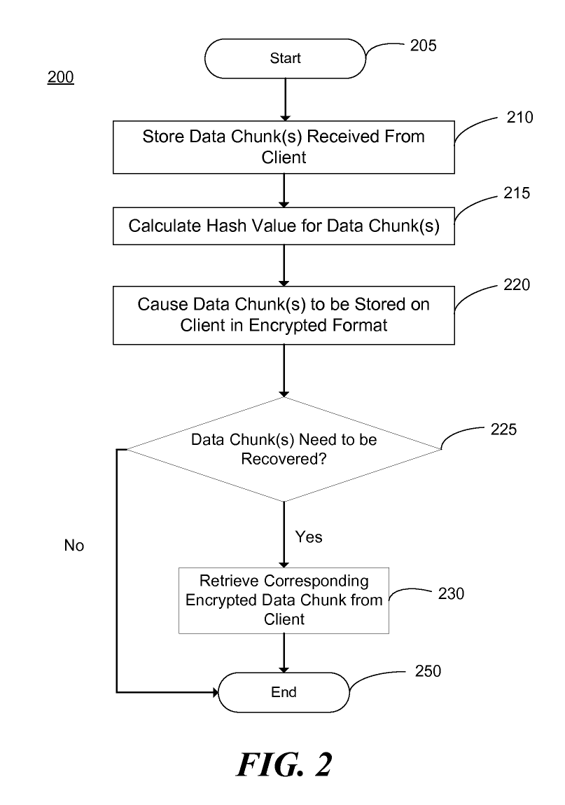

FIG. 2 is a flowchart of an example method 200 for data encryption consistent with disclosed implementations. Although execution of method 200 is described below with reference to the components of remote backup storage device 150, other suitable components for execution of method 200 may be used.

Method 200 may begin in stage 205 and proceed to stage 210 where device 150 may store a plurality of data chunks received from a client. For example, remote backup storage device 150 may receive data chunks 145(A)-(B) from a client such as device 100 and write those chunks to a database or other data element storage 160. In some implementations, device 150 may receive data element 140 and then break it into chunks for storage.

Method 200 may advance to stage 215 where device 150 may calculate a hash value for each of the plurality of data chunks. The hash value associated with each data chunk may be calculated according to a hash function such as MD5. Hashes for the data chunks may be calculated using the same hash function on client device 100 and remote backup storage device 150 and the hash values may be stored independently of the data chunks. Any potential loss of the data chunks may thus not involve loss of the hash values. In the event of loss of the data chunks on the backup target, the backup target may query the clients for the corresponding chunk data. For example, if a backup target has lost data chunk C, then it may query all clients with the hash value for data chunk C. A client that has an encrypted data chunk corresponding to the hash value for data chunk C may send that encrypted data chunk back to the backup target. The backup target may decrypt the encrypted data chunk from the client to recover the missing data chunk C.

Method 200 may advance to stage 220 where device 150 may cause the plurality of data chunks to be stored on the client in an encrypted format. For example, remote backup storage device 150 may provide the public key of a key pair to client device 100 for use in encrypting the data chunks 145(A)-(B) remaining on the client after data element 140 has been deleted.

Method 200 may advance to stage 225 where device 150 may determine whether a stored data chunk needs to be recovered. For example, device 150 may index the stored data chunks according to the calculated hash value such as by creating a memory map and/or data table cross-referencing the hash value with the storage location for its respective data chunk. In some implementations, determining whether the stored data chunk needs to be recovered may comprise determining whether the stored data chunk associated with the one of the indexed hash values is missing and/or corrupted. For example, a periodic re-indexing may be performed to verify that all data chunks are present and/or the hash value may be re-calculated and compared to the indexed hash value to determine if the data chunk may have become corrupted.

If device 150 determines that a stored data chunk needs to be recovered, method 200 may advance to stage 230 where device 150 may retrieve a corresponding data chunk from the client in the encrypted format. In some implementations, retrieving the corresponding data chunk from the client in the encrypted format may comprise providing the hash value for the stored data chunk to the client. For example, remote backup storage device 150 may provide the hash value for the missing and/or corrupted data chunk to the original source client and/or to a plurality of clients that send data to device 150 for backup storage. The client(s) may use an index of hash values to determine whether they have stored the encrypted version of the needed data chunk.

In some implementations, retrieving the corresponding data chunk from the client in the encrypted format may comprise verifying the corresponding data chunk retrieved from the client. Verifying the corresponding data chunk retrieved from the client may comprise, for example, decrypting the corresponding data chunk retrieved from the client, calculating a new hash value for the decrypted corresponding data chunk, and comparing the new hash value for the decrypted corresponding data chunk to the hash value for the stored data chunk.

If no data chunk is determined to need to be recovered at stage 225, or after the corresponding data chunk has been retrieved from the client in the encrypted format, method 200 may end at stage 250.

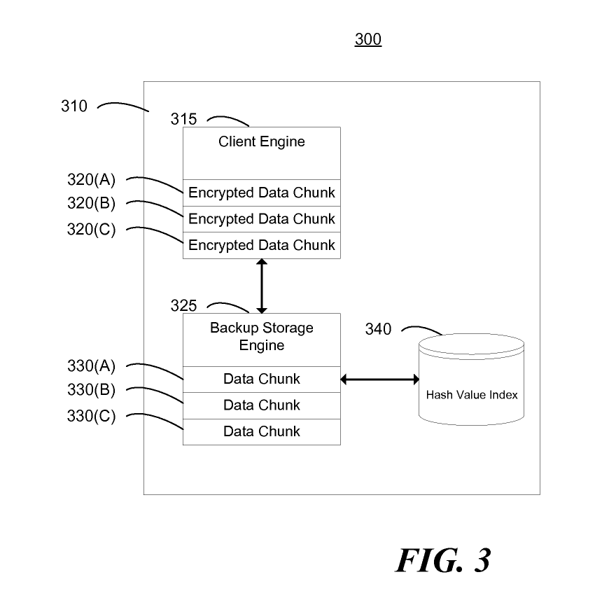

FIG. 3 is a block diagram of an example system 300 for providing data encryption. System 300 may comprise a computing device 310 comprising a client engine 315 to divide a data element into a plurality of data chunks, calculate a hash value for each of the plurality of data chunks, encrypt the plurality of data chunks according to a public key associated with a backup storage engine 325, store the encrypted plurality of data chunks in a local storage, index the encrypted plurality of data chunks in the local storage according to the calculated hash values, provide the unencrypted plurality of data chunks to the backup storage engine 325, and delete the unencrypted plurality of data chunks from the local storage.

For example, client engine 315 may perform divide data element instructions 132 to divide data element 140 plurality of data chunks 145(A)-(B). Client engine 315 may also perform encrypt data chunk instructions 134 and store encrypted data chunk instructions 136 to encrypt the data chunks according to the public key associated with backup storage engine 325 and store the encrypted data chunks 320(A)-(C) in locally accessible storage. Store encrypted data chunk instructions 136 may comprise instructions to calculate a hash value for each of the encrypted plurality of data chunks. For example, an md5 hash value may be calculated for each of data chunks 145(A)-(B). The hash value may be used to index the data chunks 145(A)-(B), such as by creating a memory map and/or data table cross-referencing the hash value with the storage location for its respective data chunk.

Device 310 may further comprise backup storage engine 325 to store the unencrypted plurality of data chunks received from the client engine, index the unencrypted plurality of data chunks according to the calculated hash values, determine whether at least one data chunk of the plurality of unencrypted data chunks needs to be recovered, and in response to determining that the at least one data chunk needs to be recovered, request a corresponding encrypted data chunk from the client engine according to the calculated hash value associated with the at least one data chunk.

For example, backup storage engine 325 may receive unencrypted data chunks 330(A)-(C) from client engine 315 write those chunks to a database or other data element storage. In some implementations, backup storage engine 325 may receive data element 140 and then break it into data chunks 330(A)-(C) for storage.

Backup storage engine 325 may calculate a hash value for each of the plurality of data chunks 330(A)-(C). The hash value associated with each data chunk 330(A)-(C) may be calculated according to a hash function such as MD5. Hashes for the data chunks may be calculated using the same hash function on client engine 315 and backup storage engine 325 and the hash values may be stored independently of the data chunks. For example, a hash value index 340 may be created as a database table. In the event of loss of the data chunks 330(A)-(C) on backup storage engine 325, the backup storage engine 325 may query client engine 315 for the corresponding encrypted data chunk(s) 320(A)-(C) by requesting the encrypted data chunk associated with the hash value used to index the needed data chunk.

The disclosed examples may include systems, devices, computer-readable storage media, and methods for data encryption. For purposes of explanation, certain examples are described with reference to the components illustrated in the Figures. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Moreover, as used in the specification and the appended claims, the singular forms “a,” “an,” and “the” are intended to include the plural forms as well, unless the context indicates otherwise. Additionally, although the terms first, second, etc. may be used herein to describe various elements, these elements should not be limited by these terms. Instead, these terms are only used to distinguish one element from another.

Further, the sequence of operations described in connection with the Figures are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples. All such modifications and variations are intended to be included within the scope of this disclosure and protected by the following claims.

We claim:

1. A non-transitory machine-readable storage medium comprising instructions to:
divide a data element into a plurality of data chunks;
encrypt the plurality of data chunks;
store the encrypted plurality of data chunks in a local storage; and
provide the data element to a remote backup storage.

2. The non-transitory machine-readable medium of claim 1, wherein the instructions to provide the data element to the remote backup storage further comprise instructions to delete the data element from the local storage.

3. The non-transitory machine-readable medium of claim 1, wherein the instructions to encrypt the plurality of data chunks comprise instructions to encrypt the plurality of data chunks according to a public key associated with the remote backup storage.

4. The non-transitory machine-readable medium of claim 1, wherein a size of each of the plurality of data chunks is defined by the remote backup storage.

5. The non-transitory machine-readable medium of claim 1, wherein the instructions to store the encrypted plurality of data chunks in the local storage comprise instructions to store the encrypted plurality of data chunks in a hidden location of the local storage.

6. The non-transitory machine-readable medium of claim 1, wherein the instructions to store the encrypted plurality of data chunks in the local storage comprise instructions to calculate a hash value for each of the encrypted plurality of data chunks.

7. The non-transitory machine-readable medium of claim 6, wherein the instructions to calculate the hash value for each of the encrypted plurality of data chunks comprise instructions to index the encrypted plurality of data chunks according to the calculated hash value.

8. A computer-implemented method, comprising:
storing a plurality of data chunks received from a client;
calculating a hash value for each of the plurality of data chunks;
causing the plurality of data chunks to be stored on the client in an encrypted format;
determining whether a stored data chunk needs to be recovered; and
in response to determining that the stored data chunk needs to be recovered, retrieving a corresponding data chunk from the client in the encrypted format.

9. The computer-implemented method of claim 8, wherein retrieving the corresponding data chunk from the client in the encrypted format comprises providing the hash value for the stored data chunk to the client.

10. The computer-implemented method of claim 8, wherein retrieving the corresponding data chunk from the client in the encrypted format comprises verifying the corresponding data chunk retrieved from the client.

11. The computer-implemented method of claim 10, wherein verifying the corresponding data chunk retrieved from the client comprises:
decrypting the corresponding data chunk retrieved from the client;
calculating a new hash value for the decrypted corresponding data chunk; and
comparing the new hash value for the decrypted corresponding data chunk to the hash value for the stored data chunk.

12. The computer-implemented method of claim 8, wherein determining whether the stored data chunk needs to be recovered comprises determining whether the stored data chunk associated with the one of a plurality of indexed hash values is missing.

13. The computer-implemented method of claim 8, wherein the encrypted format is associated with a private key not available to the client.

14. The computer-implemented method of claim 8, wherein retrieving the corresponding data chunk from the client comprises:
providing the hash value to a plurality of clients; and
determining which of the plurality of clients comprises the client storing the encrypted data chunk associated with the hash value.

15. A system, comprising:
a client engine to:
divide a data element into a plurality of data chunks,
calculate a hash value for each of the plurality of data chunks,
encrypt the plurality of data chunks according to a public key associated with a backup storage engine,
store the encrypted plurality of data chunks in a local storage,
index the encrypted plurality of data chunks in the local storage according to the calculated hash values,
provide the unencrypted plurality of data chunks to the backup storage engine, and
delete the unencrypted plurality of data chunks from the local storage;
the backup storage engine to:
store the unencrypted plurality of data chunks received from the client engine,
index the unencrypted plurality of data chunks according to the calculated hash values,
determine whether at least one data chunk of the plurality of unencrypted data chunks needs to be recovered, and
in response to determining that the at least one data chunk needs to be recovered, request a corresponding encrypted data chunk from the client engine according to the calculated hash value associated with the at least one data chunk.
